(19) United States
(12) Patent Application Publication
(10) Pub. No.: US 2021/0331121 A1
(43) Pub. Date: Oct. 28, 2021

(54) Nano Carbon Immobilized Membranes for Selective Membrane Distillation

(71) Applicant: New Jersey Institute of Technology, Newark, NJ (US)

(72) Inventors: Somenath Mitra, Bridgewater, NJ (US); Sagar Roy, Newark, NJ (US); Oindrila Gupta, Harrison, NJ (US)

(73) Assignee: New Jersey Institute of Technology, Newark, NJ (US)

(21) Appl. No.: 17/225,424

(22) Filed: Apr. 8, 2021

Related U.S. Application Data
(60) Provisional application No. 63/013,768, filed on Apr. 22, 2020.

(51) Int. Cl. B01D 69/14; B01D 61/36; B01D 71/02; C02F 1/44

(52) U.S. Cl. CPC B01D 69/141; B01D 61/364; B01D 61/366; C02F 2101/34; B01D 71/024; C02F 1/445; B01D 2311/13; B01D 71/021

(57) ABSTRACT

A membrane distillation (MD) system includes a membrane module and reduced graphene oxide-carbon nanotube immobilized membrane for organic solvent separation. The MD module could include a feed inlet and outlet, a sweep gas inlet, and a sweep gas outlet. Thermostats are positioned at the feed inlet and outlet to measure the change in temperature. Preferential sorption of the organic, specifically tetrahydrofuran (THF), on a hybrid reduced graphene oxide-carbon nanotube immobilized membrane contributes to enhanced solvent removal of the MD system.

### CROSS-REFERENCE TO RELATED APPLICATION

The present application claims priority benefit to a U.S. provisional patent application entitled “Nano Carbon Immobilized Membranes for Selective Membrane Distillation,” which was filed on Apr. 22, 2020, and assigned Ser. No. 63/013,768. The entire content of the foregoing provisional application is incorporated herein by reference.

### STATEMENT REGARDING FEDERALLY SPONSORED RESEARCH

This invention was made with government support under Agreement No. 1603314 awarded by the National Science Federation (NSF). The government has certain rights in the invention.

### FIELD OF THE DISCLOSURE

The present disclosure relates to systems and methods for solvent recovery or concentration via a membrane distillation (MD) system and associated methodology. In particular, the present disclosure relates to sweep gas membrane distillation (SGMD) using hybrid nanomaterial-based membranes.

### BACKGROUND

Tetrahydrofuran (THF) is an important solvent that is widely used in organic synthesis and also to produce poly-tetra-methylene glycol (PTMEG). THF's separation from an aqueous medium is industrially significant as it is an expensive solvent. Moreover, separation/recovery of THF from aqueous systems is beneficial from a water pollution perspective. THF forms an azeotrope with water at 95 wt. % water, reacts readily with oxygen on coming in contact with air, and produces an unstable hydro peroxide. Distillation of peroxide-containing THF increases the peroxide concentration resulting in a serious risk of explosion. This mixture is difficult to separate using a normal distillation process and such separation can only be performed through azeotropic distillation. Both azeotropic distillation and conventional distillation consume high levels of energy.

Pervaporation (PV) has been used to dehydrate THF using hydrophilic membranes. However, a more efficient recovery of low concentration THF from water using an organophilic membrane is of significant interest.

Membrane distillation (MD) is an emerging membrane separation technology. MD has a huge potential application in the fields of organic solvent recovery, desalination and water purification, wastewater treatment, fruit juice concentration, removal and recovery of low boiling components from aqueous mixtures, membrane crystallization, and the like.

In a MD process, only vapor molecules are selectively passed through a porous hydrophobic membrane. The feed solution is at an elevated temperature (e.g., −40° C. to −70° C.) in a conventional MD process. The driving force for separation is (i) the difference in vapor pressure among the solvents at a particular temperature and (ii) a concentration gradient between the feed side and the permeate side. MD has several advantages over conventional distillation, such as lower operating temperatures and lower capital investment. MD can be combined with other membrane processes, such as ultrafiltration (UF), PV, and reverse osmosis (RO). Furthermore, the heat required in a MD process can be obtained from alternative energy sources, such as solar energy or microwave energy, thereby making the MD process more energy efficient.

The different MD configurations generally used to maintain a vapor pressure difference across a MD membrane include direct contact MD (DCMD), sweep gap MD (SGMD), air gap MD (AGMD), and vacuum MD (VMD). Sweep gas MD modules using reduced graphene oxide-carbon nanotube membranes have been demonstrated. A sweep gas MD module has the advantage of relatively low conductive heat loss and less energy consumption than vacuum MD.

Carbon nanotube (CNT) based membranes have been used in a variety of separation applications that include pervaporation, extraction and nanofiltration. The physicochemical interaction between the solutes and the membrane can be dramatically altered by immobilizing CNTs on the membrane surface. First, CNTs are excellent sorbents that have surface areas between 100 and 1000 m²/g. Many factors, such as the presence of defects, capillary forces in nanotubes, polarizability of graphene structure, lead to strong sorbate/sorbent interactions. The absence of a porous structure leads to high specific capacity while facilitating fast desorption of large molecules. A more recent development in MD is a carbon nanotube immobilized membrane (CNIM) for desalination where the CNTs increase the partitioning of the water vapor while rejecting hydrogen bonded salt-water phase leading to a dramatic increase in flux.

Despite efforts-to-date, a need remains for improved systems and methods for removal of THF and other similar chemicals/compounds from a liquid in an efficient and effective manner, including systems and methods that are less energy intensive.

### SUMMARY

In accordance with embodiments of the present disclosure, materials and methods for sweep gas membrane distillation are described herein, where various embodiments of the materials and methods may include some or all of the elements and features described below. The materials and methods disclosed herein enhance and/or maximize vapor flux, providing an enhanced solvent removal rate from the feed solution. Even though the current subject matter has specific application in alcohol concentration or recovery for use in paint or pharmaceutical industries, the materials and methods disclosed herein may be employed in other applications including, but not limited to, solvent usage in paint, plastic, petroleum and/or pharmaceutical industries.

Graphene oxide (GO) and reduced GO (r-GO) are important nanocarbons where the atomic-level thickness with controlled pore size make them viable options for membrane modifiers. The comparatively higher hydrophobicity of r-GO compared to GO translate to improved performance for hydrophobic membranes that include r-GO in MD systems.

In SGMD with r-GO-CNTs, significant enhancement in solvent flux is observed due, in whole or in part, to preferential sorption and fast desorption to the permeate side via CNTs serving as nanosorbents. The rGO membranes include a laminate structure with a nano-sized interlayer spacing. The spacing inside the laminates acts as a nanocapillary through which ions/solvents can selectively permeate. The presence of interlayer spacing in r-GO also potentially contributes to enhanced flux via selective sieving of THF with respect to water in a THF-water mixture.

In the present disclosure, an exemplary hybrid membrane system for THF separation from water via MD is disclosed. The disclosed hybrid membrane system takes into account experimental data and most significantly data reported in the literature for other solvent systems selected in terms of temperature and THF concentration.

Embodiments discussed herein include novel membranes, such as a reduced graphene oxide and carbon nanotube (rGO-CNT) membranes, which are not limited to organic solvent removal/recovery for industrial usage and may be used for other applications, including desalination, acid concentration, and wastewater treatment.

In accordance with one or more disclosed embodiments, MD systems discussed herein include at least one SGMD module and a liquid nitrogen trap to condense the permeated component.

In one or more disclosed embodiments, an MD module disclosed herein includes a feed inlet to receive an aqueous feed solution and a feed outlet, and a condensing medium (sweep gas) inlet and outlet to obtain a condensing medium and to remove a stream of solvent vapor from the MD module, respectively. The SGMD membrane module is connected back to the feed reservoir to allow recirculation of the feed solution.

The membrane module may be employed in the form of a hollow fiber membrane module, a flat membrane module, or a spiral wound membrane module in exemplary embodiment(s) of SGMD systems and methods disclosed herein.

In accordance with one or more disclosed embodiments, novel nanocarbons (NCs) are disclosed, which may be incorporated into membranes. Such membranes are referred to herein as nanocarbon immobilized membranes (rGO-CNIM). These NCs may serve to alter the chemical properties thereof, leading to specific interactions with solutes, to changes in hydrophobicity, and to combinations thereof. For purposes of the present disclosure, NCs of all types are included, such as carbon nanotubes (CNTs, referred to as CNIMs when immobilized in a membrane), graphene oxide and reduced graphene oxide (GO & r-GO, referred to as GOIM & rGOIM when immobilized on a membrane surface). A hybrid nanocarbon consisting of CNTs and r-GO (designated as rGO-CNIM when immobilized) as disclosed herein may be employed in exemplary embodiment(s), for example, to increase solvent separation efficiency in membrane distillation (MD).

In further disclosed embodiments, methods are disclosed to measure the unknown concentration of the recirculated feed solution using a refractive index using a standard calibration curve.

In an exemplary disclosed embodiment, a membrane distillation system and method is disclosed. The exemplary membrane distillation system employs a membrane module and rGO-CNT, GO-CNT, rGO-CNIM, or GO-CNIM for organic solvent separation or recovery. In one disclosed embodiment, the membrane module includes a feed inlet and outlet, a sweep gas inlet, and a sweep gas outlet.

In one or more disclosed embodiments, the MD system disclosed herein includes flowmeter(s) to measure the feed flow rate and/or sweep gas/vacuum flowrate connected to the feed and permeate inlet, respectively. The flowmeter(s) function to limit sweep gas/vacuum flow into the permeate channel to allow a higher degree of air-sweeping in the permeate channel and thus enable a higher degree of evaporation rate from the membrane module.

As noted, the membranes disclosed herein may be employed in a membrane distillation apparatus of any/all types, and may be used in other non-distillation applications as well. In some disclosed embodiments, a membrane distillation apparatus including the disclosed membranes is a solvent recovery apparatus.

Any combination and/or permutation of the disclosed embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed membrane distillation system and associated systems and methods, reference is made to the accompanying figures, wherein:

FIG. 1 is a schematic diagram of a MD system in accordance with one or more embodiments of the present invention;

FIG. 2A is an SEM image of the surfaces of a plain PTFE membrane;

FIG. 2B is an SEM image of a GOIM construct in accordance with one or more embodiments of the present invention;

FIG. 2C is an SEM image of a rGOIM construct in accordance with one or more embodiments of the present invention;

FIG. 2D is an SEM image of a CNIM construct in accordance with one or more embodiments of the present invention;

FIG. 2E is an SEM image of a rGO-CNIM construct in accordance with one or more embodiments of the present invention;

FIG. 3A is a graphical depiction of a thermogravimetric analysis of a rGO-CNIM in accordance with one or more embodiments of the present invention and an unmodified PTFE membrane;

FIG. 3B is a graphical depiction of differential thermogravimetric (DSC) curves of a rGO-CNIM in accordance with one or more embodiments of the present invention and an unmodified PTFE membrane;

FIG. 4A is a photograph of the contact angle of pure water drop on an unmodified PTFE membrane;

FIG. 4B is a photograph of the contact angle of pure water drop on a GOIM construct in accordance with one or more embodiments of the present invention;

FIG. 4C is a photograph of the contact angle of pure water drop on a rGOIM construct in accordance with one or more embodiments of the present invention;

FIG. 4D is a photograph of the contact angle of pure water drop on a CNIM construct in accordance with one or more embodiments of the present invention;

FIG. 4E is a photograph of the contact angle of pure water drop on a rGO-CNIM construct in accordance with one or more embodiments of the present invention;

FIG. 5A is a photograph of 5 (w/w %) THF-water mixture on an unmodified PTFE membrane;

FIG. 5B is a photograph of 5 (w/w %) THF-water mixture on a GOIM construct in accordance with one or more embodiments of the present invention;

FIG. 5C is a photograph of 5 (w/w %) THF-water mixture on a rGOIM construct in accordance with one or more embodiments of the present invention;

FIG. 5D is a photograph of 5 (w/w %) THF-water mixture on a CNIM construct in accordance with one or more embodiments of the present invention;

FIG. 5E is a photograph of 5 (w/w %) THF-water mixture on a rGO-CNIM construct in accordance with one or more embodiments of the present invention;

FIG. 6A is a graphical depiction of data reflecting THF flux with PTFE membrane, GOIM, rGOIM, CNIM, and rGO-CNIM constructs as a function of the THF feed concentration at a feed flowrate of 112 mL/min, feed temperature of 40° C., and sweep gas flowrate of 4.5 L/min, in accordance with one or more embodiments of the present invention;

FIG. 6B is a graphical depiction of data reflecting separation factor with PTFE membrane, GOIM, rGOIM, CNIM, and rGO-CNIM constructs as a function of the THF feed concentration at a feed flowrate of 112 mL/min, feed temperature of 40° C., and sweep gas flowrate of 4.5 L/min, in accordance with one or more embodiments of the present invention;

FIG. 7A is a graphical depiction of data reflecting THF flux with PTFE membrane, GOIM, rGOIM, CNIM, and rGO-CNIM constructs as a function of the feed temperature at a feed flowrate of 112 mL/min, feed concentration of 5 (w/w %) and sweep gas flowrate of 4.5 L/min, in accordance with one or more embodiments of the present invention;

FIG. 7B is a graphical depiction of data reflecting separation factor with PTFE membrane, GOIM, rGOIM, CNIM, and rGO-CNIM constructs as a function of the feed temperature at a feed flowrate of 112 mL/min, feed concentration of 5 (w/w %) and sweep gas flowrate of 4.5 L/min, in accordance with one or more embodiments of the present invention;

FIG. 8A is a graphical depiction of data reflecting THF flux with PTFE membrane, GOIM, rGOIM, CNIM and rGO-CNIM constructs as a function of the feed flowrate at a feed temperature of 40° C. and feed concentration of 5 (w/w %) in accordance with one or more embodiments of the present invention;

FIG. 8B is a graphical depiction of data reflecting separation factor with PTFE membrane, GOIM, rGOIM, CNIM and rGO-CNIM constructs as a function of the feed flowrate at a feed temperature of 40° C. and feed concentration of 5 (w/w %) in accordance with one or more embodiments of the present invention;

FIG. 9A is a schematic depiction of a proposed mechanism for rGO-CNIM performance in accordance with one or more embodiments of the present invention;

FIG. 9B is a schematic depiction of a proposed mechanism for the nanocapillary effect of rGO in accordance with one or more embodiments of the present invention;

TABLE 1 reflects liquid entry pressure (LEP) data for PTFE, GOIM, rGOIM, CNIM & rGO-CNIM constructs;

TABLE 2 reflects apparent activation energy (Eₐₚₚ) values for 5 (w/w %) THF in feed for PTFE, GOIM, rGOIM, CNIM & rGO-CNIM constructs; and

TABLE 3 reflects mass transfer coefficient data for THF at different temperatures for 5 (w/w %) THF in feed at 112 mL/min.

### DETAILED DESCRIPTION

Exemplary embodiments are directed to the solvent recovery or concentration of THF from water. It should be understood that embodiments can generally be applied to other solvents besides THF.

The following is a detailed description of the invention provided to aid those skilled in the art to practice the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is to describe particular embodiments only and is not intended to limit the invention. All publications, patent applications, patents, figures, and other references mentioned herein are expressly incorporated by reference in their entirety.

The terminology used herein is to describe particular embodiments only and is not intended to limit the invention. As used herein, the singular forms “a”, “an” and “the” are intended to include the plural forms as well, unless the context clearly indicates otherwise. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

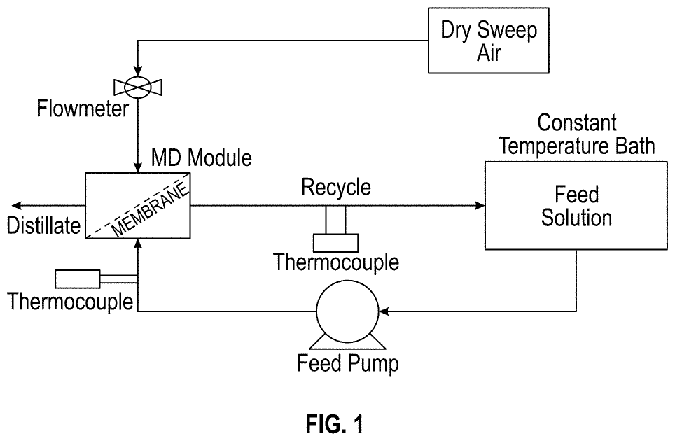

Now referring to FIG. 1, one embodiment of a MD system includes a polymeric membrane, which has a layer including reduced graphene oxide (r-GO) and carbon nanotubes (CNTs) immobilized on a polytetrafluorethylene surface (PTFE). For the sake of brevity, the layer including r-GO and CNTs immobilized in the PTFE may be referred to herein as the rGO-CLAIM layer. The rGO-CNIM layer may be further disposed on a porous substrate. The MD system could include a feed solution, a feed pump, one or more thermocouples, a flowmeter, and dry sweep air.

In one embodiment, the feed solution used in the present embodiment could be maintained in a constant temperature bath. The feed solution could be pumped by the feed pump from a feed tank to a membrane module, which includes the polymeric membrane. The membrane module could include a feed inlet, a feed outlet, a sweep gas inlet, and a sweep gas outlet. A dry sweep air flows into the membrane module. The rate of the dry sweep air could be controlled by the flowmeter. Because temperature could affect the flux of the feed solution, one or more thermocouples could be employed. After passing through the membrane module, a portion of the feed solution is separated as a distillate. The recycled feed in FIG. 1 moves to the feed tank.

The carbon nanotubes could be any suitable carbon nanotube, such as those commercially available from Cheap Tubes Inc., Brattleboro, Vt. The CNTs may be single or multi-walled. The diameter of the CNTs may range from about 1 nm to about 100 nm. The length of the CNTs may range from about 1 to about 25 μm. The graphene oxide particle sizes may range from about 10 to 30 nm. Reduction of GO to r-GO was modified for step-wise reduction by adding different amount of zinc (Zn) to the solution and details of this process has been published [See, S. Azizighannad, S. Mitra, Stepwise Reduction of Graphene Oxide (GO) and Its Effects on Chemical and Colloidal Properties, Scientific reports, 8 (2018) 10083.] Reducing the amount of Zn resulted in the formation r-GO containing 31, 19, and 9% oxygen, respectively. 9% oxygen was considered to be the most hydrophobic and was thus chosen for THF separation experiments.

In general, carbon nanotubes (CNTs) are excellent sorbents that have the ability to absorb organic solvents and desorb large molecules. As is known to those skilled in the art, many factors, such as the presence of defects, capillary forces in the laminate structure of r-GO, polarizability of graphene structure, lead to strong sorbate/sorbent interactions and allow selective sieving of THF with respect to water in a THF-water mixture due to the presence of r-GO. As used herein, in some embodiments, preferential sorption and fast desorption of the organic solvent to the permeate side via r-GO-CNTs serving as nanosorbents is discussed. The organophilic CNT surface is selective toward organic solvents due to its organic nature.

In accordance with certain embodiments, methods of making reduced graphene oxide-carbon nanotube-immobilized membranes may include the steps of dispersing a plurality of reduced graphene oxide-carbon nanotubes (1:1) in acetone to form a rGO-CNT dispersion, and then dispersed in a solution containing 0.1 mg of polyvinylidene fluoride (PVDF) in 10 ml of acetone by sonicating for three hours. The PVDF-nanocarbon dispersion was coated or filtered. The PVDF served as glue that held the nanocarbons in place within the membrane. The membrane was flushed with acetone to remove excess nanocarbons.

### Examples & Experiments

The materials and the methods of the present disclosure used in one embodiment will be described below. While the embodiment discusses the use of specific compounds and materials, it is understood that the present disclosure could employ other suitable compounds or materials. Similar quantities or measurements may be substituted without altering the method embodied below.

Acetone (AR≥99.5%) and THF (anhydrous, ≥99.5%) were obtained from Sigma-Aldrich (St. Louis, Mo.). Deionized water (Barnstead 5023, Dubuque, Iowa) was used in the experiments and the examples. Raw multi-walled carbon nanotubes (CNTs) were purchased from Cheap Tubes Inc., Brattleboro, Vt. The average diameters of the CNTs were about 30 nm and a length of up to 15 μm. Graphene oxide was obtained from Graphenea Inc. with particle sizes in the range of from 10 to 30 nm. The membrane employed for this MD experiment was a PTFE membrane on PP support (Advantec MFS, Inc.; Dublin, Calif., 0.2 μm pore size, 74% porosity).

In one embodiment, 1:1 ratio of r-GO and raw CNTs were dispersed in acetone (10 g) via sonication for 3 hrs. PVDF (0.2 mg) was added to the above solution, which acts as a binder.

The GOIM, rGOIM, CNIM, rGO-CNIM and unmodified PTFE membranes were characterized by using scanning electron microscopy (JEOL; model JSM-7900F). This was done by cutting the membranes into 0.5 cm long pieces and coating with carbon films. Thermogravimetric analysis (TGA) was used to investigate the degradation of modified membrane materials during heating. TGA was carried out using a Perkin-Elmer Pyris 7 TGA system at a heating rate of 10° C./min under air. Contact angle measurements were made to study the hydrophobic nature of the nanocarbon based membranes. These measurements were performed using a digital video camera mounted at the top of the stage.

Now referring to FIG. 1, one embodiment of an experimental setup for THF vapor removal from a simulated air stream is shown using MD. A flat membrane module was used to make the SGMD test cell that was fabricated from polytetrafluoroethylene (PTFE). The desired THF vapor concentration was achieved by carefully adjusting the flow rates of the sweep gas streams using a flow controller, a flow meter, and a pressure gauge. The feed temperature was varied from 25-50° C. using thermistor thermometers (K-type, Cole Parmer) placed on the inlet and outlet of the stream. The THF solvent concentrations were varied 2.5-10 wt. %.

A vacuum pump was connected to the feed-side of the module and the feed was recirculated to measure the change in volume after each experiment. The highly hydrophobic membranes allowed preferential passage of the solvent vapor through the membrane. Dry air supplied was passed through the permeate side of the membrane from the fume hood at room temperature (22° C.). In order to remove impurities in the dry sweep air such as dust or moisture, laboratory air from the fume hood was circulated through a drying unit (W. A. Hammond Drierite, Xenia, Ohio) and hollow Fiber Filter (Barnstead International, Beverly, Mass.) prior to flow into the permeate side. The drying unit helps to lower the relative humidity close to zero. In all experiments, the air flow rate was maintained at 4.5 L/min. The experiments were performed thrice to ensure reproducibility and the relative standard deviation was observed to be below 1%.

The change in volume between the original feed and the recirculated feed was estimated to measure the permeate concentration. The reduction in feed volume was measured after 1 h of the experiment and the THF-water mixture composition before and after the experiment was evaluated using a Refractive Index meter (EW 81150-55, Cole Parmer). A calibration curve was plotted for THF concentration vs refractive index at room temperature to measure the unknown concentration of THF after each experiment.

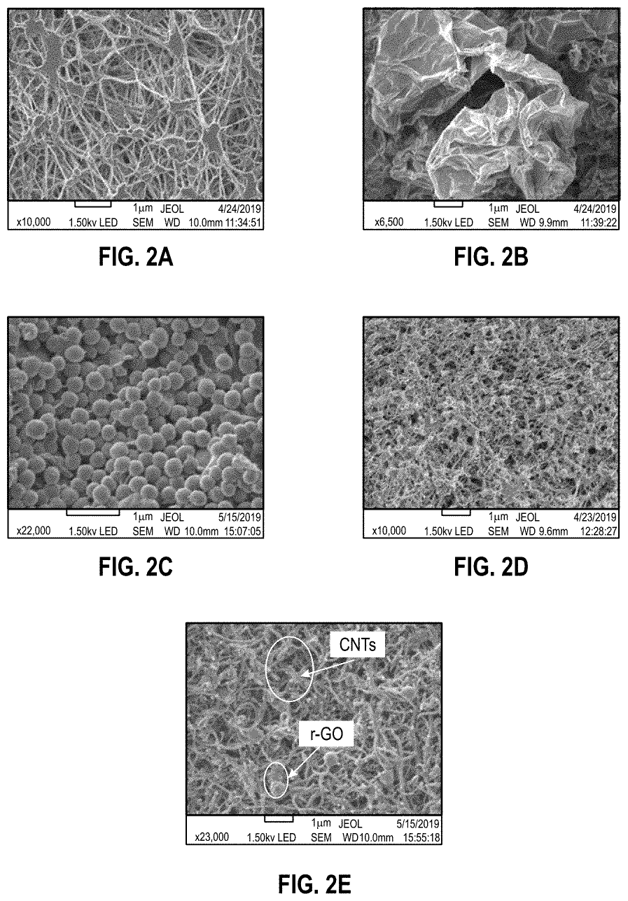

Now referring to FIGS. 2A-2E, SEM images of the surfaces of a plain PTFE substrate, GOIM, rGOIM, CNIM, and rGO-CNIM are shown, respectively. The porous structure of the PTFE membrane and presence of the nanocarbons can be clearly seen. Uniform distribution of the nanocarbons over the entire membrane surface was observed. From FIG. 2B, it can be seen that the surface of GO exhibited a layered sheet structure that can be attributed to layer-by-layer stacking of GO. The GO sheets included a smooth surface with few folded regimes and wrinkles. The structural image of rGO-CNTs is shown in FIG. 2E. From the image, it can be seen that graphene and carbon nanotubes were well adhered to each other.

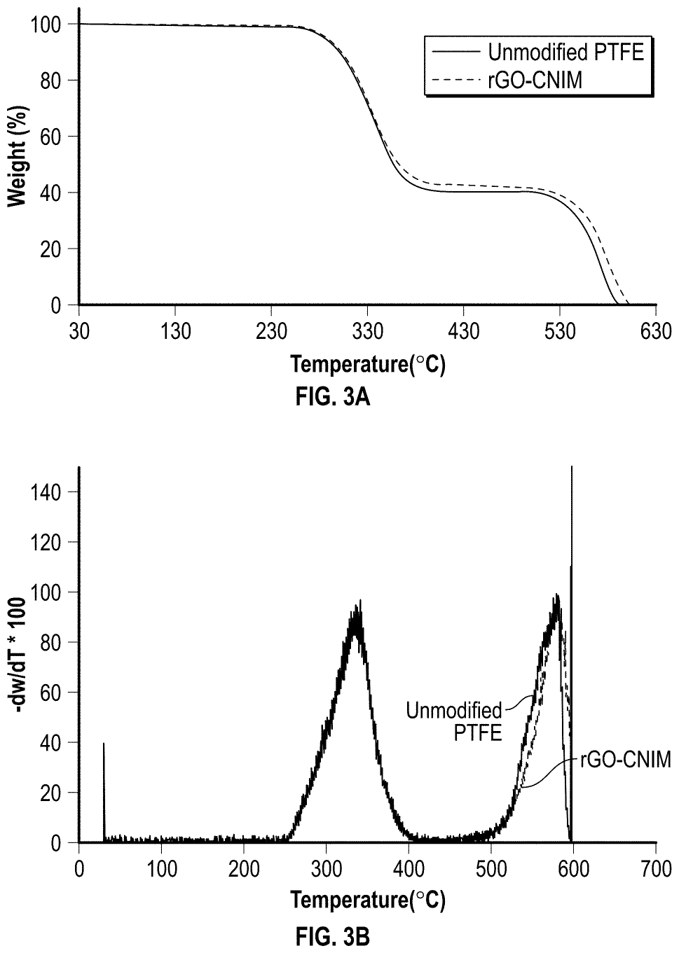

Now referring to FIGS. 3A and 3B, thermal degradation behavior and thermal stability of the PTFE and rGO-CNIM were studied by thermogravimetric analysis (TGA). FIG. 3A reflects the TGA curve of the fabricated membranes. It is clear from FIG. 3A that the membrane is quite stable at a moderate temperature. It is observed that the initial thermal decomposition of the membrane began at −250° C. (degradation of PP support layer), followed by the degradation of PTFE active layer at 530° C. FIG. 3B shows the DSC curves of the fabricated membranes. A relatively high glass transition temperature was observed at 250° C.

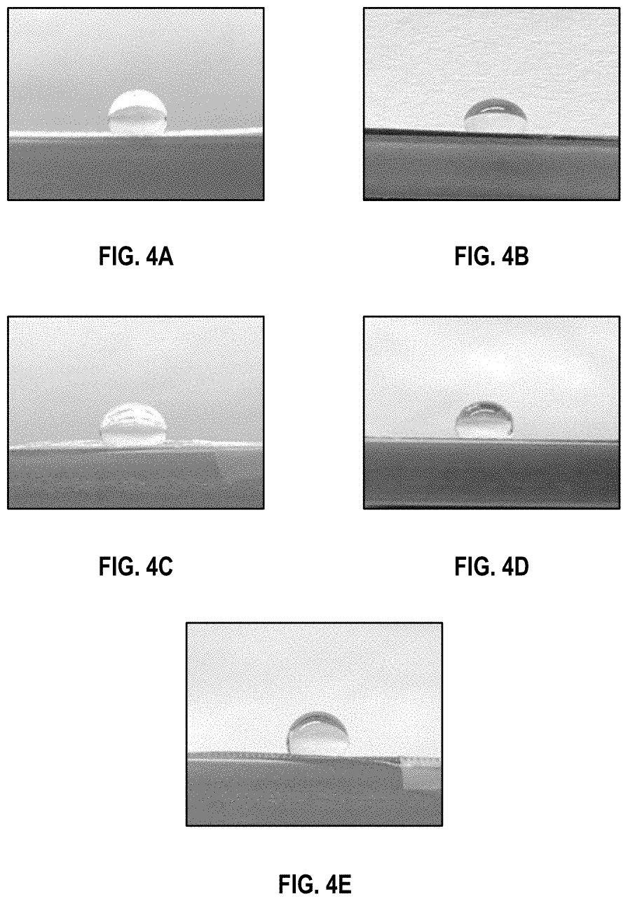

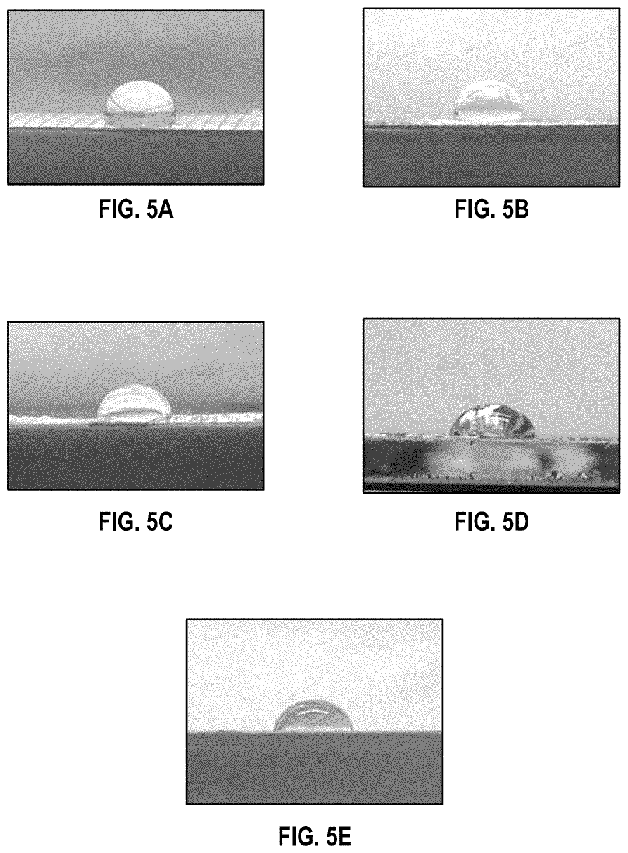

Referring to FIGS. 4A-4E and FIGS. 5A-5E, the contact angles for pure water were much higher on nanocarbon based membranes due to their higher hydrophobicity, which were similar to what has been reported previously. The presence of THF resulted in strong interactions with the rGO-CNIM, CNIM, and rGOIM. For rGO-CNIM, the contact angle with pure water and aqueous THF solution was observed to be 112° and 80°, respectively, showing a reduction of 28.6%, the highest among all the fabricated membranes. The respective reduction in contact angle for the samples were 15.8% and 8.4% for rGOIM and GOIM, respectively. The increased hydrophobicity of rGO led to a stronger affinity for the organic solvent, indicating improved THF separation performance of rGOIM over GOIM. In general, increase in THF affinity to the r-GOIM, CNIM, and rGO-CNIM over unmodified PTFE and GOIM were observed and was expected to improve the separation performance.

The liquid entry pressure (LEP) of pure water for PTFE, rGOIM, CNIM, and rGO-CNIM was found to be −66 psig, respectively, and for GOIM, the value was −58 psig. The LEP decreased to 59, 68, 71, 75, and 58%, respectively for 15 (w/w %) THF-water mixture from pure water as evident from Table 1. The high LEP values indicate the low wettability of the membranes as also evident from the contact angle measurements described above. The prolonged use of feed concentration higher than 15% could lead to membrane wetting and leakage of the feed mixture into the permeate side, thus was not used in the present experiments. It is well-known that LEP depends on contact angle (hydrophobicity), pore size, surface energy, and surface tension for the feed solution, and the presence of organic materials in feed solution reduces the LEP of hydrophobic membrane. The contact angle reduced with increasing THF concentration, thus resulting in a lower LEP.

### Performance of GOIM, rGOIM, CNIM, rGO-CNIM, and PTFE

THF-water separation was quantified based on flux and separation factor. The performance of GOIM, rGOIM, CNIM, rGO-CNIM and a commercial PTFE membrane were compared. The solvent vapor flux, J_{w}, across the membrane was defined as

$${J}_{w} = \frac{{W}_{p}}{t \times A} \qquad ( 1 )$$

where Wp was the total mass of the permeate, t is the time, and A is the effective membrane surface area.

Selectivity was quantified as a separation factor, which was a measure of preferential transport of organic solvent and was defined as

$${α}_{solvent - water} = \frac{{y}_{solvent} / {y}_{water}}{{x}_{solvent} / {x}_{water}} \qquad ( 2 )$$

where yᵢ and xᵢ are the weight fraction of the component ‘i’ in permeate and feed, respectively.

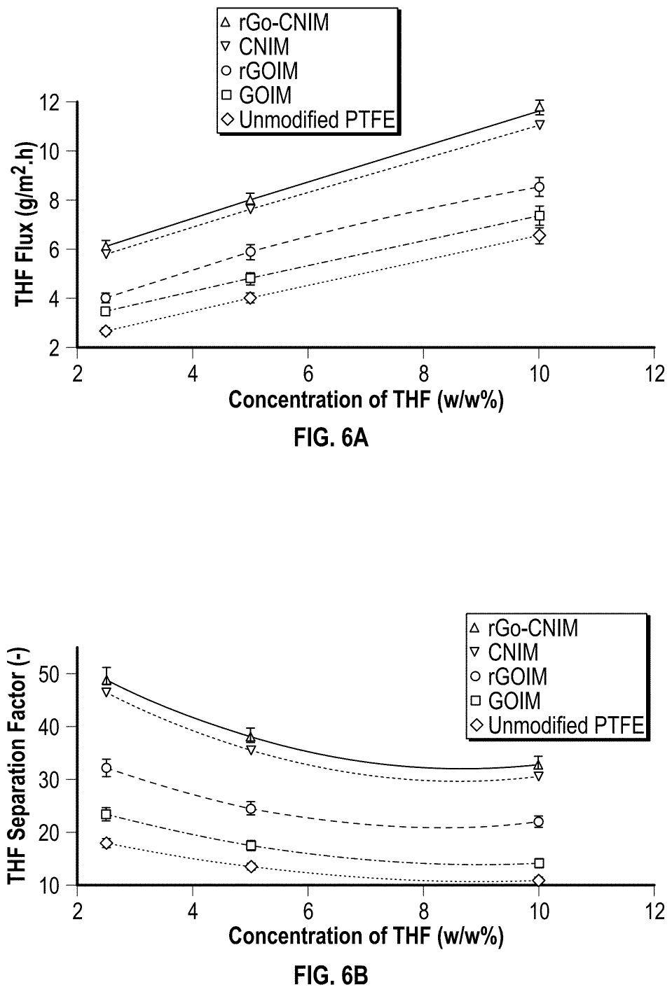

Now referring to FIG. 6A, the THF flux and separation factor is shown at various THF concentrations in the feed with GOIM, rGOIM, CNIM, rGO-CNIM, and PTFE membranes, respectively. THF feed concentrations of 2.5, 5, and 10 (w/w %) were studied. The temperature in the THF-water feed mixture and the feed side flow rate was kept constant at 40° C. and 112 mL/min, respectively. It can be observed from the figures that with increase in THF concentration in feed, the flux increased for all membranes. All of the nanomaterial immobilized membranes exhibited improved separation performance compared to the PTFE membrane. The THF flux reached as high as 4.8, 5.9, 7.6, and 8 g/m²·h, for GOIM, rGOIM, CNIM, and rGO-CNIM, respectively, at 5 (w/w %) of THF in the feed, which were 20%, 47.2%, 91.2, and 101% higher, respectively, compared to the PTFE membrane. The highest THF flux for rGO-CNIM can be attributed to the higher THF affinity, as also supported by the contact angle measurement and activated diffusion via frictionless CNTs surfaces through the membrane pores. The presence of oxygenated functionalities (hydroxyl, carboxyl, epoxy) on GO may have limited the preferential interaction with the organic moiety and quick transport of the THF on the GO frameworks, thus reducing the improvement in flux.

Now referring to FIG. 6B, separation factor of THF as a function of feed concentration is presented. It is evident from the plot that the separation factor is inversely proportional to the THF concentration for all the membranes. However, a higher separation factor for rGO-CNIM and CNIM than rGOIM, GOIM, and PTFE membranes was observed at all tested THF feed concentrations. Enhancement over the PTFE membrane for THF reached as high as 29.7% for GOIM and 82.1% for rGOIM, 163% for CNIM, and 181.8% for rGO-CNIM at 5 (w/w %) THF and 40° C.

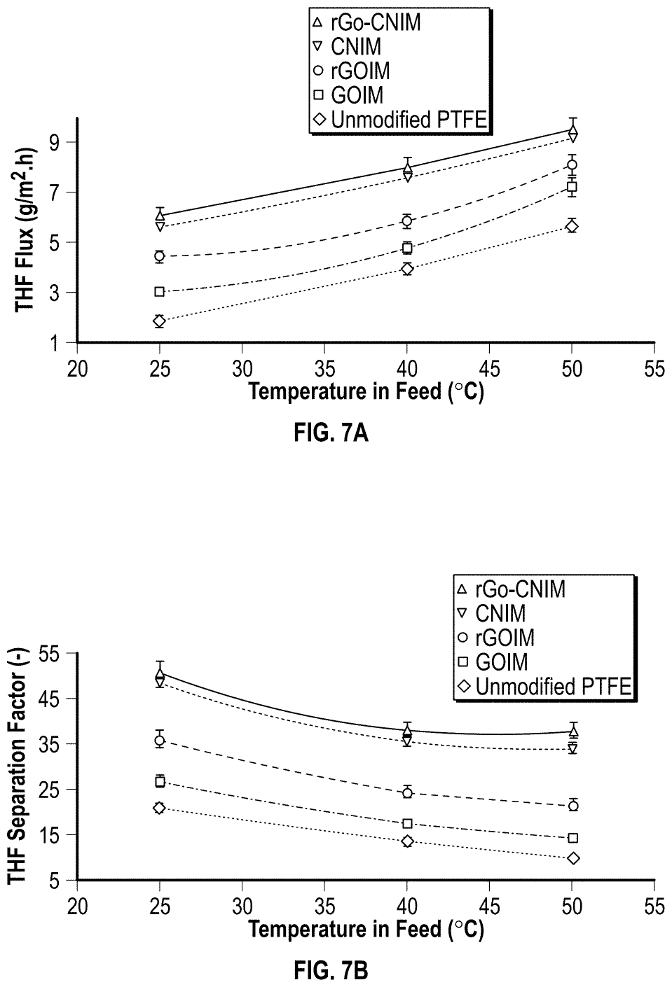

Now referring to FIGS. 7A-B, the effects of THF flux and separation factor on the unmodified PTFE, GOIM, rGOIM, CNIM, and rGO-CNIM as a function of feed temperatures are demonstrated. A feed concentration 5 (w/w %) THF at a feed flowrate of 112 mL/min was maintained. The permeate fluxes for all membranes increased with an increase in feed temperature. It is well known that the vapor pressure increased exponentially with temperature and the sharp increase in THF vapor pressure (148.45 mm Hg to 439.574 mm Hg) from 40 to 60° C. was reflected in the corresponding increase in THF flux. At 50° C., the THF flux reached up to 7.2 g/m²·h, 8.1 g/m²·h, 9.2 g/m²·h, and 9.5 g/m²·h for GOIM, rGOIM, CNIM. and rGO-CNIM, respectively with 5 (w/w %) THF in feed, which were significantly higher than previously reported data for pervaporation [2, 3]. In general, higher fluxes at all temperatures for rGO-CNIM and CNIM were observed followed by rGOIM and GOIM, although the enhancement was distinct at a reduced temperature. At 50° C., the improvement in THF flux reached up to 26.7, 42.3, 60.8, and 66.7% for GOIM, rGOIM, CNIM, and rGO-CNIM, respectively, over a pristine PTFE membrane. Hence, experiments can be done at a relatively lower temperature with an effort to make the process sustainable and less energy consuming.

From FIG. 7B, it can be interpreted that at all the operating temperatures, the combination of r-GO and CNTs played a vital role in separating THF from aqueous medium compared to the commercial PTFE membrane and the other two fabricated membranes. The separation factor enhancement of GOIM, rGOIM, CNIM, and rGO-CNIM compared to PTFE membrane reached as high as 46.9, 123, 263, and 279.2% at 50° C., respectively. A decline in THF separation factor was observed with an increase in feed temperatures for all membranes due to negative viscosity effects. Increase in feed temperatures also exponentially increased the water vapor pressure that resulted in a higher amount of water diffusing through the membrane. Consequently, the partition coefficient of THF decreased with temperature, which in turn reduced the overall THF selectivity.

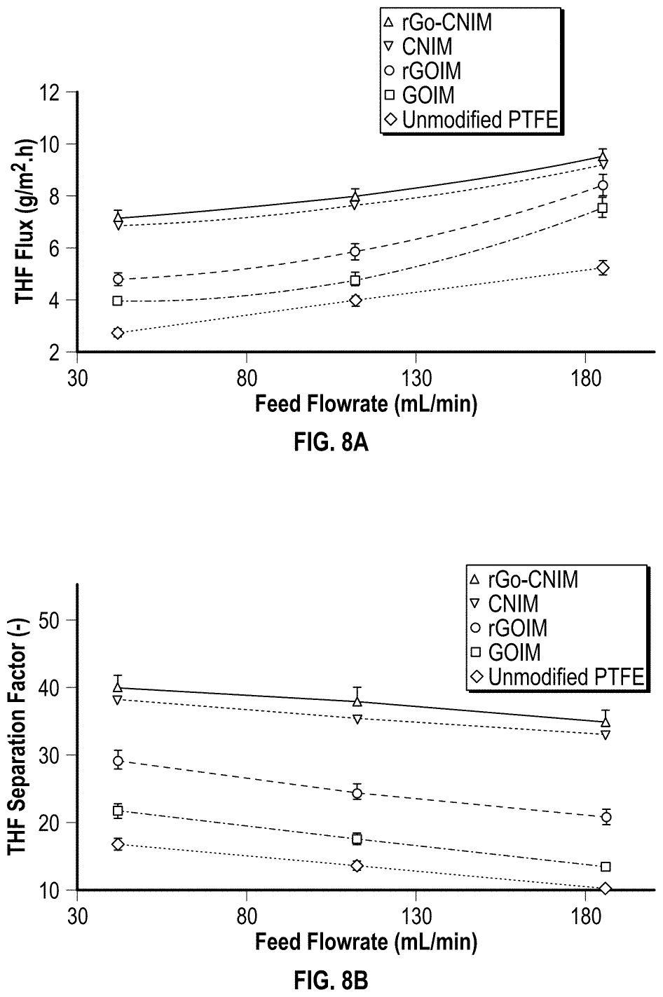

FIGS. 8A-B demonstrate the effect of varying feed flowrate on THF flux and separation factor. The feed flow rate was varied from 42 to 185 mL/min. The feed temperature and concentration were kept constant at 40° C. and 5 (w/w %). The permeate flux and separation factor for rGO-CNIM increased as high as 9.5 g/m² h and 34.9, respectively, at the highest feed flow rate. The increase in flux was much more in the case of rGO-CNIM and CNIM than the unmodified PTFE and enhancement reached as high as 82.7% and 76.9%. This can be explained by the temperature and concentration polarization phenomenon. Increasing the flow rate results in a reduction of the difference between concentrations at the bulk from that of the membrane surface. At low flow rates, THF concentration was depleted at the liquid-membrane interface resulting in a lower flux. Higher feed flow increased the turbulence, which in turn increased the THF concentration and the vapor pressure on the feed-membrane interface resulting in an increase in the THF flux. Higher THF removal efficiencies can be attributed to increased heat and mass transfer from the bulk feed to the membrane surface. It is evident from the figures that the rGO-CNIM and CNIM exhibited higher separation factor at all feed flow rates compared to the unmodified membrane and GOIM. The partitioning of the THF on the CNTs and r-GO in the rGO-CNIM was also reduced with increasing feed flowrate. At high flow rates, the residence time is short and relatively less amount of THF partitions on the rGO-CNIM and CNIM resulting in a decline in separation factor at higher flowrates.

Apparent activation energy (Eₐₚₚ) for THF transport through porous hydrophobic membranes in SGMD mode was calculated from Eq. (3) Where J and Jo are fluxes (mol m⁻² h⁻¹), R is gas constant (J mol⁻¹ K⁻¹), T_{f} denotes feed temperature (K). The concentration of THF was kept constant at 5 (w/w %). The Eₐₚₚ values for PTFE, GOIM, rGOIM, CNIM, and rGO-CNIM are shown in Table 2. It is clear from the table that the presence of r-GO and CNTs significantly reduced the apparent activation energy for THF. Among four membranes used, rGO-CNIM exhibited the lowest Eₐₚₚ value followed by CNIM, rGOIM, GOIM, and PTFE membranes.

$$J = {J}_{0} exp ( - \frac{{E}_{app}}{{RT}_{f}} ) \qquad ( 3 )$$

The mass transfer coefficient k was calculated from flux J_{w} as:

J_{w}=k(P_{f}−Pₚ) (4)

where, P_{f} and Pₚ are the partial pressure in feed and permeate side. The vapor pressure of THF at a particular temperature was obtained from literature and the Pₚᵢ, was considered to be almost zero as completely dried sweep air was used on the permeate side of the membrane.

Table 3 presents the variation in mass transfer coefficient in PTFE and nanocarbon immobilized membranes at different feed temperatures and THF (5 w/w %)-water mixture at a constant feed flowrate of 112 mL/min. The modified membranes showed improved mass transfer coefficient over the pristine PTFE membrane at all feed temperatures. Among the modified membranes, rGO-CNIM exhibited the highest ‘k’ followed by CNIM, rGOIM, and GOIM. The enhancement of mass transfer coefficient over PTFE reached as high as 20.3% for GO, 47.1% for rGOIM, 90.9% for CNIM, and 100.7% for rGO-CNIM at 40° C. The CNTs are known to provide rapid sorption/desorption properties, which contributed to high mass transfer coefficients. The mass transfer coefficients decreased or remained same with increase in operating temperature for all membranes. It is known that at higher temperatures, the temperature polarization increases significantly, resulting in a lower membrane mass transfer coefficient.

### Membrane Stability

Membrane stability in presence of strong organic solvents, such as THF, is an important factor, which needed to be considered. SGMD experiments were performed for 8 h per day for 60 days with 10 (w/w %) THF concentration at the highest temperature of 50° C. The THF flux was estimated from time to time. No considerable decline in flux and membrane wetting were observed during prolonged membrane usage. The recycled feed solution was carefully inspected. It can be stated that there was no substantial r-GO or CNT loss from the surface of the membranes with extensive use. Similar membrane stability checks have been performed before where CNIM was used at very high temperatures in aqueous solutions for extended periods and then examined for CNT loss.

### Exemplary Mechanism

Among the nanomaterials immobilized membranes, GOIM exhibited lowest solvent removal performance, followed by rGOIM, CNIM, and rGO-CNIM. This may be due to the presence of polar functional groups on a GO surface that interact with the water molecules and eventually reduced the organic species transport through the membrane. The reduction in polar moiety on rGOIM increased the hydrophobicity, hence the organic solvent affinity, which improved the solvent separation performance than GOIM. The CNTs are known to have high solvent sorption capacity and activated diffusion on its frictionless smooth surface that provides an edge over the other membranes.

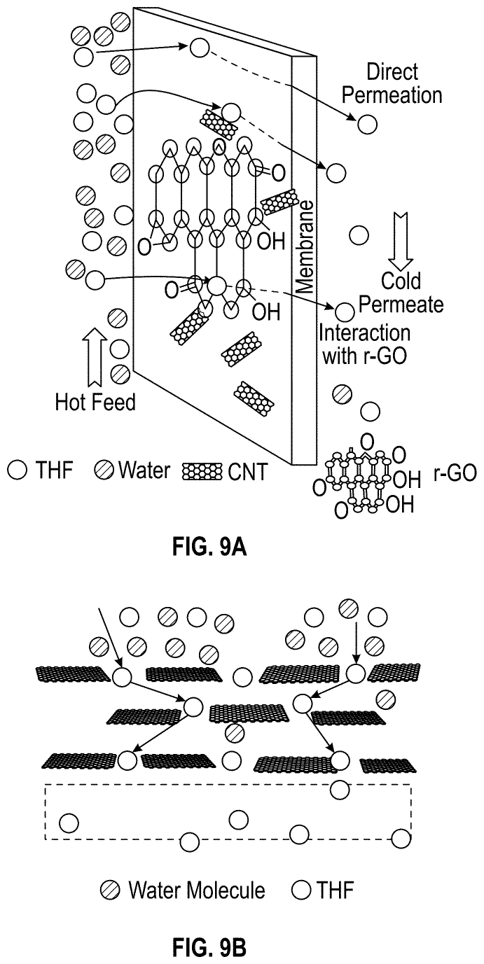

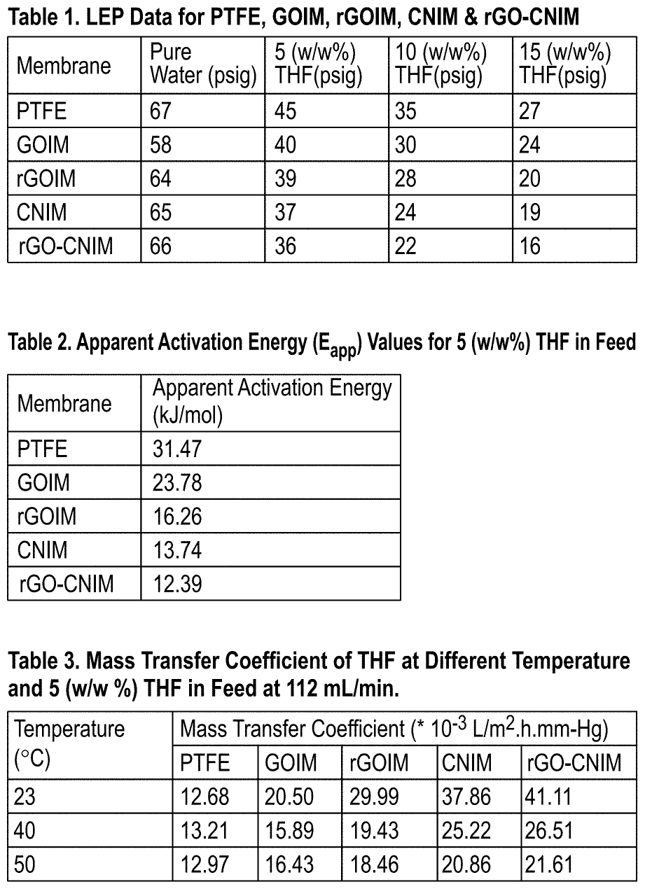

FIGS. 9A and 9B illustrate the schematic of the transport mechanism of THF through rGO-CNIM. In rGO-CNIM, the presence of r-GO and CNTs together play a vital role in selective permeation of THF through the membrane. The high porosity and surface area of r-GO along with its tunable hydrophobicity and nanocapillary effect has shown superior adsorption capacity for organic solvent. Earlier research has also validated the high sorbent capability and faster desorption rate of organic species on CNTs surface with rapid mass transport. Placing well-dispersed CNTs within 2D graphene sheets provides effective sorption sites for THF vapor, allowing an uniform network to form, which can provide many mass transfer channels through the continuous 3D nanostructure, resulting in the high permeability and separation performance of the r-GO-CNT hybrid membranes in the case of organics. Organic moieties have a greater interaction with graphene-carbon nanotube walls resulting in an improved separation performance. The rGO membranes have a laminate structure with a nano-sized interlayer spacing. The spacing inside the laminates acts as a nanocapillary through which ions/solvents can selectively permeate through. It may be possible that the presence of interlayer spacing in r-GO also aids to enhance flux via selective sieving of THF with respect to water in THF-water mixture, which is in line with previous studies published [4].

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention. All references listed and/or referred to herein are incorporated by reference in their entireties.

### REFERENCES

[1] S. Azizighannad, S. Mitra, Stepwise Reduction of Graphene Oxide (GO) and Its Effects on Chemical and Colloidal Properties, Scientific reports, 8 (2018) 10083.
[2] P. Das, S. K. Ray, Pervaporative recovery of tetrahydrofuran from water with plasticized and filled polyvinylchloride membranes, Journal of industrial and engineering chemistry, 34 (2016) 321-336.
[3] S. Li, V. A. Tuan, R. D. Noble, J. L. Falconer, Pervaporation of water/THF mixtures using zeolite membranes, Industrial & engineering chemistry research, 40 (2001) 4577-4585.
[4] D. Cohen-Tanugi, J. C. Grossman, Water desalination across nanoporous graphene, Nano letters, 12 (2012) 3602-3608.

1. A membrane distillation system, comprising:
a. a membrane module; and
b. a carbon nanotube and graphene oxide membrane that together define a nanocarbon immobilized membrane, the nanocarbon immobilized membrane associated with the membrane module;
wherein the nanocarbon immobilized membrane is sized to separate an organic solvent.

2. The membrane distillation system of claim 1, wherein the nanocarbon immobilized membrane is a reduced graphene oxide and carbon nanotube immobilized hybrid membrane.

3. The membrane distillation system of claim 2, wherein the reduced graphene oxide-carbon nanotube immobilized membrane is sized to separate tetrahydrofuran from water.

4. The membrane distillation system of claim 1, wherein the membrane module comprises a sweep gas inlet and a sweep gas outlet.

5. The membrane distillation system of claim 1, wherein the membrane module comprises a liquid nitrogen trap.

6. The membrane distillation system of claim 1, wherein the nanocarbon immobilized membrane is selected from the group consisting of a hollow fiber membrane module, a flat membrane module, and a spiral wound membrane module.

7. The membrane distillation system of claim 1, wherein the nanocarbon immobilized membrane is selected from the group consisting of an rGO-CNT, GO-CNT, rGO-CNIM and a GO-CNIM construct.

8. The membrane distillation system of claim 1, wherein the carbon nanotube is selected from the group consisting of a single walled and multi-walled constructs.

9. The membrane distillation system of claim 1, wherein the carbon nanotube has a diameter of 1 nm to 100 nm.

10. The membrane distillation system of claim 1, wherein the carbon nanotube has a length of 1 μm to 25 μm.

11. The membrane distillation system of claim 1, wherein the graphene oxide comprises reduced graphene oxide.

12. The membrane distillation system of claim 1, wherein the graphene oxide has a particle size of 10 nm to 20 nm.

13. A method to separate a chemical constituent from water, comprising the steps of:
providing a sweep gas membrane distillation module having a graphene oxide-carbon nanotube immobilized membrane; and
passing a feed solution through the sweep gas membrane distillation module to separate the chemical constituent from the water.

14. The method of claim 13, wherein the chemical constituent is tetrahydrofuran.

15. The method of claim 13, wherein the graphene oxide is reduced graphene oxide.

16. The method of claim 13, wherein the graphene oxide-carbon nanotube immobilized membrane is selected from the group consisting of a hollow fiber membrane module, a flat membrane module, and a spiral wound membrane module.

17. The method of claim 13, wherein the graphene oxide-carbon nanotube immobilized membrane is selected from the group consisting of an rGO-CNT, GO-CNT, rGO-CNIM and a GO-CNIM construct.

18. The method of claim 13, wherein the carbon nanotube is selected from the group consisting of a single walled and multi-walled constructs.
